(19) United States
(12) Patent Application Publication
(10) Pub. No.: US 2026/0131762 A1
(43) Pub. Date: May 14, 2026

(54) SYSTEM FOR A CAR WASH

(71) Applicant: Project 2025, LLC, Shelby Township, MI (US)

(72) Inventors: Samei PATAQ, Birmingham, MI (US); Fadi PATAQ, Birmingham, MI (US)

(73) Assignee: Project 2025, LLC, Shelby Township, MI (US)

(21) Appl. No.: 19/359,637

(22) Filed: Oct. 15, 2025

Related U.S. Application Data
(60) Provisional application No. 63/707,458, filed on Oct. 15, 2024.

(51) Int. Cl. B60S 3/04; B05B 1/34; B05B 13/04; B08B 3/14; B25J 9/16; B25J 11/00; B25J 15/00; B60S 3/00; C02F 1/28; C02F 1/44; C02F 103/44; F26B 5/00; G01S 17/894

(52) U.S. Cl. CPC B60S 3/04; B05B 1/34; B05B 13/0433; B08B 3/14; B25J 9/1676; B25J 9/1682; B25J 11/0085; B25J 15/0019; B60S 3/002; C02F 1/283; C02F 1/441; F26B 5/00; G01S 17/894; B08B 2230/01; C02F 2103/44

(57) ABSTRACT

The disclosure relates to an automated steam-based vehicle cleaning system and method. The system includes a steam generator, a multi-axis robotic arm equipped with a steam nozzle, a steam distribution manifold, and an air delivery system for drying. A three-dimensional imaging system, comprising overhead and side-mounted sensors, generates detailed representations of vehicles within the cleaning chamber. A controller, integrated with the imaging system and robotic arm, processes the imaging data through a machine learning algorithm for object detection and localization. The control unit orchestrates the operation of the steam generator, robotic arm, and other components based on the processed data, ensuring precise and efficient cleaning. The method involves generating a three-dimensional model of the vehicle, detecting and localizing the vehicle, determining an optimal cleaning path, and executing the cleaning process with real-time adjustments, followed by a drying phase using forced air.

### CROSS-REFERENCE TO RELATED APPLICATIONS

This application claims the benefit of U.S. provisional application Ser. No. 63/707,458 filed Oct. 15, 2024, the disclosure of which is hereby incorporated in its entirety by reference herein.

### TECHNICAL FIELD

This disclosure relates to an automated car wash system and method of automated car washing.

### BACKGROUND

Car washing has been an essential service in the automotive industry for decades. Traditional car washing methods typically involve a combination of water, detergents, chemicals, and mechanical action to clean vehicles. These systems often use large quantities of water, ranging from 40 to 100 gallons per vehicle, depending on the wash type and size. Manual car washing relies heavily on human labor using handheld hoses, brushes, and sponges. Automated systems, like tunnel washes and rollover, use a series of brushes, high-pressure water jets, and sometimes touch-free methods involving high-pressure water and chemical cleaners. While effective to some degree, these traditional methods often struggle with thorough cleaning, especially in hard-to-reach areas of vehicles. They also face criticism for their high water consumption, not drying the car thoroughly and potential for scratching vehicle surfaces. Additionally, the use of harsh chemicals in some systems raises environmental concerns. The cleaning quality can be inconsistent, often depending on factors like the vehicle's shape and the system's maintenance.

### SUMMARY

According to at least one embodiment, an automated vehicle car wash system is provided. The system has a cleaning chamber for receiving a vehicle and an imaging system having a plurality of sensors to scan the vehicle within the cleaning chamber. A washing fluid delivery system provides a prescribed ratio of water-to-steam configured for cleaning the vehicle. An air delivery system is configured to provide air for drying the vehicle. At least one robotic arm is positioned in the cleaning chamber positioned adjacent the vehicle. A cleaning tool is attached to the robotic arm and has a plurality of cleaning nozzles operatively coupled to the washing fluid delivery system for delivering the prescribed ratio of water-to steam, and operatively coupled to the air distribution system for delivering air. A controller is operatively connected to the robotic arm, the washing fluid delivery system, the air distribution system and the imaging system. The controller is programmed to receive data from the imaging system and generate a three-dimensional surface map of the vehicle and control the robotic arm based on the three-dimensional surface map of the vehicle.

In another embodiment, the plurality of sensors includes at least one three-dimensional (3D) LiDAR sensor and at least one of a stereoscopic camera or time-of-flight camera for generating the three-dimensional surface map of a vehicle.

In another embodiment, the plurality of sensors are positioned overhead and along sides of the cleaning chamber and are configured to provide the three-dimensional surface map corresponding to an exterior of the vehicle.

In another embodiment, the controller is further programmed to process data from the imaging unit to generate a detailed 3D model of the vehicle surface.

In another embodiment, the controller has a machine learning module trained to perform object detection using data from the imaging system, the machine learning module being configured to identify exterior vehicle features.

In another embodiment, the controller generates an optimized cleaning trajectory for the robotic arm based on the 3D model and object localization data.

In another embodiment, the controller continuously modifies the cleaning trajectory in real time based on sensor feedback from the vehicle surface.

In another embodiment, the washing fluid delivery system comprises a steam generator produces steam at temperatures between 100° C. and 180° C. and pressures between 10 MPa and 20 MPa, with a variable steam-to-water ratio adjusted according to cleaning requirements.

In another embodiment, the washing fluid delivery system provides a cleaning fluid at the prescribed ratio of steam-to-water being in a volumetric ratio in the range of 1.5 to 2.0

In another embodiment, the plurality of cleaning nozzles comprise at least one a variable-geometry nozzle capable of adjusting spray angle between 30° and 40° relative to the vehicle surface.

In another embodiment, the plurality of cleaning nozzles are formed of a composite of stainless steel and copper alloy and includes a self-cleaning mechanism using high-pressure steam pulses.

In another embodiment, the robotic arm comprises six or more degrees of freedom, enabling full access to the vehicle surface, including undercarriage and recessed areas.

In another embodiment, the system at least two robotic arms, wherein the robotic arms are synchronized by the controller to perform simultaneous cleaning of different vehicle zones.

In another embodiment, dynamic safety zones are established around the robotic arms based on vehicle localization data to prevent collisions during operation.

In another embodiment, the cleaning effector is configured to switch between steam delivery and air delivery for seamless transition from washing to drying.

In another embodiment, the cleaning effector is attached to a distal end of the robotic arm and further comprises sensors that monitor surface temperature, distance, and moisture to optimize cleaning and drying results.

In another embodiment, a closed-loop water recycling subsystem includes reverse osmosis and activated carbon filtration for reusing condensed steam and runoff.

In another embodiment, the controller includes a user interface configured for local and remote operation through at least one of a touchscreen, mobile device, or voice control inputs.

According to at least one embodiment, an automated steam-based car washing system is provided and includes a steam generator. The system also includes a robotic arm with multiple degrees of freedom that is operatively connected to the steam generator. An end effector is attached to the robotic arm, and the end effector has a steam nozzle. The system further includes a manifold for distributing air delivery system for drying. A three-dimensional imaging system with at least one overhead sensor and at least one side-mounted sensor is part of the system. The system also includes a control system that is operatively connected to the robotic arm, steam generator, and two and three-dimensional imaging system. This control system has a processor that is configured to receive and process data from the two and three-dimensional imaging system, execute a machine learning algorithm for object detection and localization, and control the robotic arm and steam generator based on the processed data and object detection results.

According to at least one embodiment, an automated vehicle cleaning apparatus is provided. The apparatus includes a cleaning chamber and a vehicle positioning system within the cleaning chamber. The apparatus also includes a steam delivery system that has a steam generator and a steam distribution network. A robotic manipulation system with at least two multi-axis robotic arm is part of the apparatus. The apparatus further includes a sensing system for generating two and three-dimensional representations of vehicles within the cleaning chamber and a drying system for removing moisture from cleaned vehicles. A control unit is operatively connected to the vehicle positioning system, dynamic safety zones, steam delivery system, robotic manipulation system, sensing system, and drying system. This control unit is configured to coordinate operations of the connected systems based on the three-dimensional representations of vehicles and predefined cleaning protocols.

According to at least one embodiment, a method of operating an automated steam-based vehicle washing system is provided. First, a vehicle is received into a washing chamber. Then, a three-dimensional model of the vehicle is generated using a multi-sensor imaging system. The three-dimensional model data is processed using a machine learning algorithm to detect and localize the vehicle within the washing chamber. A cleaning path for a robotic arm is generated based on the processed three-dimensional model data and vehicle localization. The method then involves controlling a steam generator to produce steam and directing the robotic arm along the generated cleaning path. Steam is applied to the vehicle surface through a steam nozzle attached to the robotic arm. The robotic arm's position and steam application are continuously adjusted based on real-time feedback from the multi-sensor imaging system. Finally, forced air is applied to dry the vehicle surface.

### BRIEF DESCRIPTION OF THE DRAWINGS

FIG. 1 is a front view of a car wash system with a vehicle according to one embodiment of the present disclosure.

FIG. 2 is a top view of a car wash system with a vehicle according to one embodiment of the present disclosure.

FIG. 3 illustrates a car wash robot in more detail according to one embodiment of the present disclosure.

FIG. 4 is a schematic diagram of the end of arm tooling for a robotic arm according to one embodiment of the present disclosure.

FIGS. 5-8 illustrate the layout and top view of a car wash tunnel, including a wash tunnel, equipment room, electrical room, storage, and office spaces and an automated system incorporated within the existing tunnel layout according to various embodiments of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

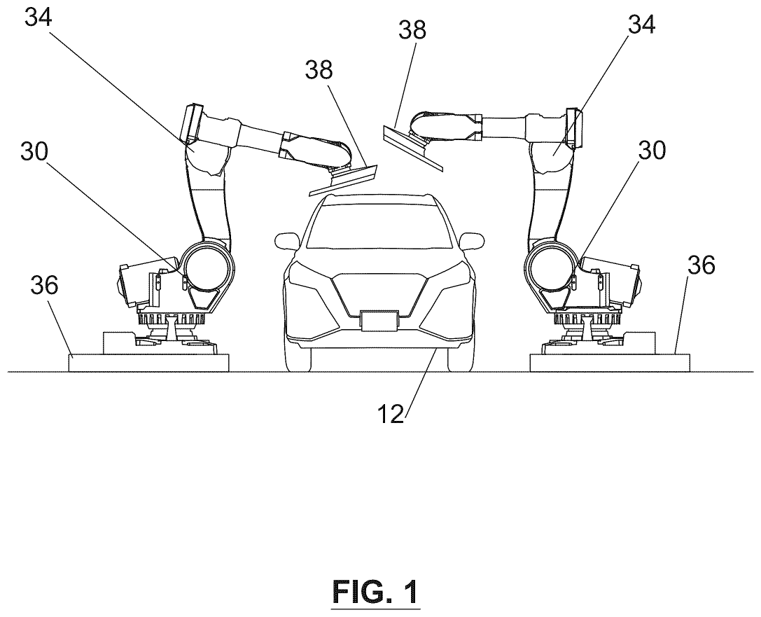

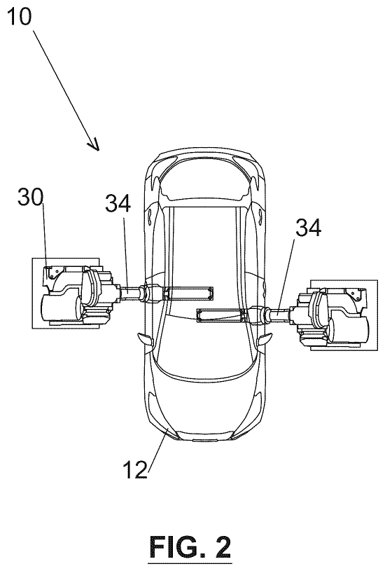

As shown in FIGS. 1-8, the present disclosure relates to an automated car wash system 10 that uses steam cleaning technology, robotics, and machine learning algorithms to deliver a vehicle cleaning experience that dynamically adapts the cleaning process to each vehicle's geometry. Conventional car wash systems rely heavily on pre-set mechanical sequences and static cleaning mechanisms that fail to adapt to the unique geometries and conditions of individual vehicles. Such systems often produce inconsistent cleaning results, leave residual moisture or debris in recessed areas, and consume excessive quantities of water and energy. Moreover, these systems typically depend on chemical detergents that can damage vehicle finishes and create environmental waste.

The car wash system 10 of the present disclosure addresses these shortcomings by integrating advanced sensing, control systems, and cleaning technologies into a cohesive automated platform. Through the use of precision robotics, intelligent control logic, and high-efficiency cleaning media, the system 10 enables a cleaning process that automatically adapts to each vehicle's size, shape, and surface condition. The system is designed to optimize cleaning performance while minimizing resource consumption, improving reliability, and reducing environmental waste compared to existing car wash systems.

Unlike prior art systems which primarily rely on predefined spray patterns and fixed washing cycles, the disclosed car wash system 10 employs adaptive control strategies that respond dynamically to vehicle characteristics and environmental conditions. This adaptability enables uniform cleaning coverage and thorough drying, even in areas that are typically difficult to access with conventional systems.

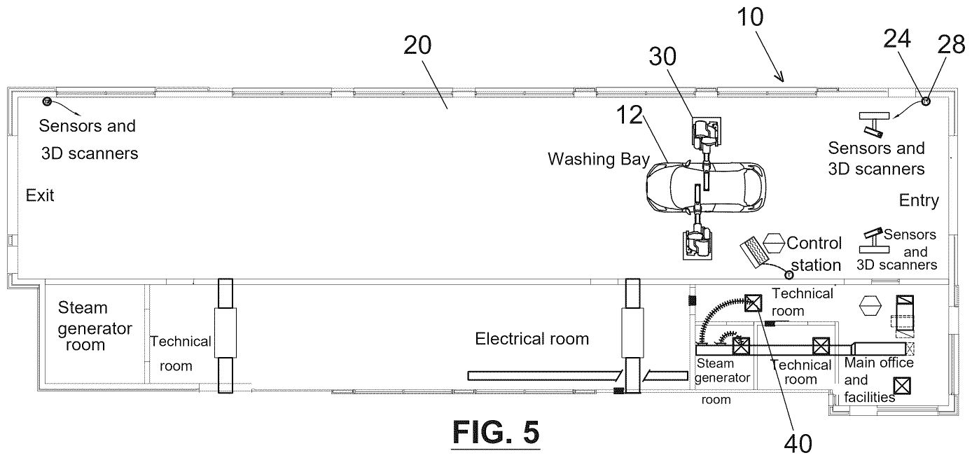

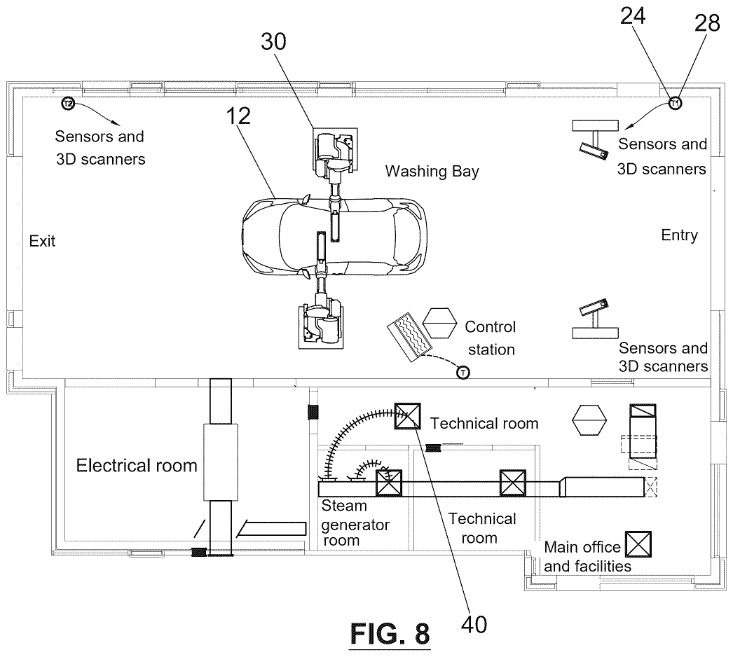

The automated vehicle car wash system 10 includes a cleaning chamber 20 configured to receive and process a vehicle during automated washing and drying operations. In one embodiment, the cleaning chamber 20 may be structured as a tunnel-type enclosure similar to those found in traditional car wash facilities, as shown in FIGS. 5-7. Such tunnels typically may range between 12 and 45 meters (approximately 40 to 150 feet) in length and have an internal width of 3 to 4.5 meters (10 to 15 feet), allowing sufficient clearance for a wide variety of vehicles. In some embodiments, the chamber 20 includes automated entry and exit doors. The cleaning chamber 20 may be scaled for use in larger facilities capable of accommodating campers, vans, recreational vehicles, and semi-trailer trucks, allowing the system 10 to serve both standard automotive and commercial transport applications. Alternatively, the cleaning chamber 20 may be a compact space, such as in FIG. 8 The chamber may also incorporate integrated drainage, ventilation, and lighting systems.

The car wash system 10 is designed to accommodate a diverse range of vehicles, from small passenger cars such as sedans, hatchbacks, and coupes, to larger vehicles including crossovers, sport utility vehicles (SUVs), pickup trucks, and specialized vehicles such as supercars, campervans, and heavy-duty trucks. The internal structure of the cleaning chamber 20 and its associated equipment are adaptable to variations in vehicle height, width, and contour, ensuring consistent and thorough cleaning across all vehicle types. This adaptability enables the system 10 to be integrated into existing car wash tunnels or deployed as a standalone automated wash installation for commercial and high-volume applications.

An imaging system 24 is positioned within and around the cleaning chamber 20. The imaging system 24 is configured to scan and capture detailed geometric data of the vehicle. The imaging system 24 includes a plurality of sensors 28 positioned to capture the vehicle's exterior surfaces. In one embodiment, the sensors 28 include three-dimensional (3D) LiDAR modules, stereoscopic cameras, and/or time-of-flight (ToF) cameras, which operate cooperatively to obtain high-resolution spatial and depth data. The LiDAR modules may use advanced solid-state technology using a combination of different wavelength lasers, such as 905 nanometer (nm) and 1550 nm lasers, or alternative technologies like frequency-modulated continuous wave (FMCW) LiDAR. Other suitable sensors 28 may be used that capture data to generate a three-dimensional surface map or three-dimensional model of the vehicle.

The sensors 28 may be positioned at various locations within the cleaning chamber 20. Overhead-mounted sensors 28 may capture the vehicle's upper surfaces, including the roof, hood, and trunk, while side-mounted sensors may scan the vertical body panels, mirrors, doors, and wheel wells. Additional sensors 28 or imaging units may be placed near the lower regions of the chamber 20 to acquire data corresponding to the undercarriage and lower trim. The arrangement of these sensors 28 allows the imaging system 24 to generate a comprehensive three-dimensional surface map or three-dimensional model of the exterior of the vehicle.

The imaging system 24 communicates the collected data to a controller 40. The controller 40 may include a computing device or processors configured to read and write data from memory. The controller can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, controller 40 can be any technically feasible hardware unit capable of processing data, executing instructions, and/or performing processing tasks, such as the processing the image data. The controller 40 can be built on a distributed architecture, employing a combination of programmable logic controllers (PLCs) for low-level control tasks and high-performance edge computing devices for computationally intensive tasks. Alternatively, the system may utilize a centralized high-performance computing unit or a cloud-based computing architecture with edge devices for low-latency operations.

Memory can include a random-access memory (RAM) module, a flash memory unit, or any other type of memory unit or combination thereof. The controller 40 is configured to read data from and write data to memory. In various embodiments, memory includes non-volatile memory, such as optical drives, magnetic drives, flash drives, or other storage. In some embodiments, separate data stores, such as an external data stores (not shown) included in a network, such as cloud storage, can supplement the memory. The image processing may be within memory and can be executed by the controller 40 to implement the overall functionality to coordinate the operation of the car wash system 10 as a whole.

The controller 40 may be configured to integrate and process the sensor inputs to form a three-dimensional surface map of the vehicle. This mapping process may combine distance, contour, and reflectivity data to define the precise geometry of the vehicle. The three-dimensional surface map provides the input data set for the system's cleaning and drying operations performed by the robotic system 30. The imaging system 24 and its processing capabilities allow the car wash system 10 to provide localized surface characterization, enabling highly targeted and efficient cleaning.

The imaging system 24 may also be able to detect regions of the vehicle exhibiting higher concentrations of dirt, debris, or contaminants. This may allow the controller 40 to adjust cleaning parameters for those localized areas such as adjusting fluid pressure, temperature, spray angle, steam-to-water ratio and/or spray duration, or other cleaning parameters. The imaging system 24 can also identify surface contours, mirrors, door handles, spoilers, or other exterior features or irregular geometries that require specialized cleaning approaches. For example, the imaging system 24 may be able to detect vehicle-specific features and electronic components found on electric and autonomous vehicles, which often have unique surface contours and sensitive sensor housings. By recognizing these features, the car wash system 10 can apply optimized cleaning and drying routines that avoid potential interference with external sensors or charging ports, for example. As a result, the car wash system 10 is able to adapt dynamically to each individual vehicle, ensuring compatibility across a broad range of vehicle designs and enabling the system to meet the evolving needs of the modern automotive industry.

The car wash system 10 includes a machine learning module integrated within the system controller 40 to enhance the accuracy and adaptability of vehicle detection and characterization. Data acquired from the imaging system 24 and sensors 28 such as the LiDAR and 3D camera systems are processed by machine learning algorithms configured for object detection, classification, and localization. In one embodiment, the machine learning module and an object detection model may include a neural network architecture or a deep convolutional neural network optimized for real-time processing. The machine learning module may divide image data into discrete regions and predict bounding boxes and classification probabilities for multiple objects within a single frame. This allows the system to rapidly and accurately identify vehicle features and surface attributes in real time. The model can be pre-trained on large, diverse datasets of vehicle images and further fine-tuned using data collected from the imaging system 24 to improve detection accuracy under varying cleanliness vehicle conditions. Alternative algorithms or custom-trained models may also be employed, including transformer-based architectures or hybrid deep learning networks designed for three-dimensional feature recognition.

The machine learning module enables the car wash system 10 to detect and classify a wide variety of exterior vehicle features, including surface contours, mirrors, door handles, spoilers, badges, trim pieces, and other irregular geometries. The module may further distinguish between reflective materials, glass, painted surfaces, and textured coatings to ensure optimal cleaning without damage. By integrating these detection capabilities into the system controller, the machine learning module allows dynamic adjustment of robotic trajectories, nozzle angles, and cleaning parameters based on the identified features. For example, if the module identifies delicate sensors or optical components on electric or autonomous vehicles, the system can automatically reduce steam pressure or adjust spray direction to avoid interference. This adaptive intelligence enables the car wash system 10 to optimize cleaning performance for each unique vehicle profile, maintaining both efficiency and safety while continuously improving through iterative data learning and model refinement.

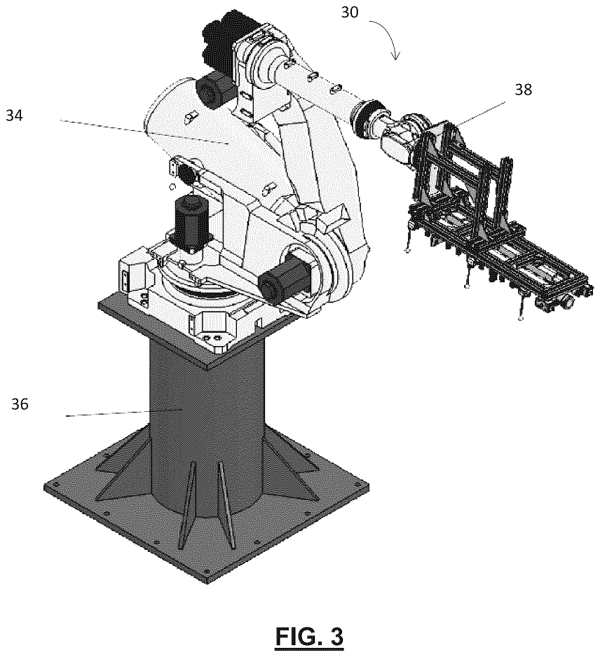

As illustrated in FIG. 3, the robotic system 30 has at least one robotic arm 34 positioned adjacent to the vehicle within the cleaning chamber 20. In some embodiments, multiple robotic arms 34 are provided and configured to operate cooperatively. As shown in the Figures, two robotic arms 34 are provided, where one robotic arm 34 is mounted on each side of the vehicle 12. Each robotic arm 34 provides six degrees of freedom to enable full spatial access to all vehicle surfaces, including the roof, undercarriage, mirrors, and recessed body regions. Other numbers of robotic arms and various degrees of freedom may be used. The robotic system 30 may fit within the cleaning chamber 20 while providing clearance between the arm and vehicle surfaces, may have sufficient vertical reach to access vehicle roofs, and may achieve full lateral coverage without repositioning the vehicle.

The robotic arm 34 may be mounted on a rigid base or track structure designed to maintain stability during high-precision cleaning operations. The robotic arms 34 are able to deliver both reach and payload capacity suitable for supporting an attached end effector tool 38 while maintaining rapid motion control and collision avoidance within the confined geometry of the cleaning chamber 20. In one embodiment, the robotic arm 34 may have a payload capacity from 8 kilograms to 165 kilograms or more and have a reach length ranging from approximately 1.8 to 3.5 meters or more.

The robotic arm 34 is able to access the top and sides of the vehicle, while maintaining sufficient precision to prevent contact with vehicle surfaces. The robotic arms 34 may be mounted on a base 36 to provide additional reach for reaching the top of vehicles. The robotic arms 34 may have a linear translation mechanism to extend the reach to the center of the front and rear of the vehicle, when required.

The robotic system 30 is configured to support both single- and dual-arm modes of operation. In a dual-arm configuration, the controller 40 may synchronize the two robotic arms 34 positioned on opposite sides of the vehicle to perform simultaneous cleaning of distinct zones, thereby reducing total cycle time.

The robotic system 30 includes the end effector tool 38 mounted to the distal end of the robotic arm 34. The end effector tool 38 is an end of arm tool that may include a cleaning manifold with a plurality of nozzles for delivery of cleaning fluid. The end effector tool 38 may also have a nozzle connected to air delivery systems, and sensors for feedback control. The robotic arms 34 may communicate with the controller 40, which ensure coordinated movement and synchronization.

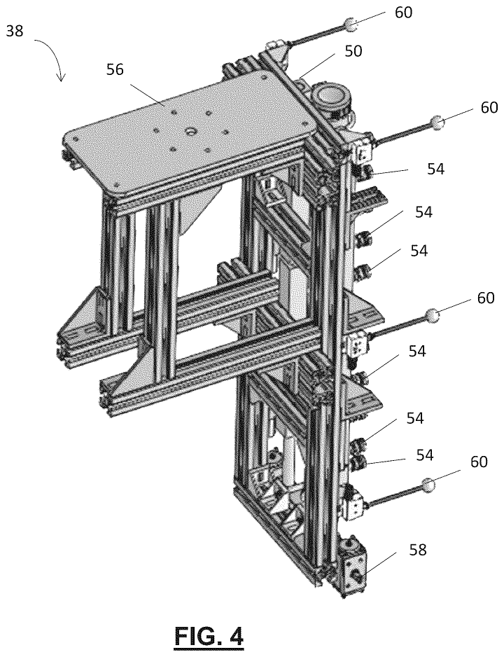

As shown in FIGS. 3 and 4, the end effector tool 38 is operatively attached to the distal end of each robotic arm 34 and is the interface for delivering cleaning fluids and air in the car wash system 10. The end effector tool 38 includes a cleaning manifold 50 configured to distribute washing fluid, steam, and drying air through internal channels. The cleaning manifold 50 may be made of corrosion-resistant materials, such as stainless steel or alloy composites, to withstand high-temperature and high-pressure operating conditions. Within the manifold 50, separate conduits may be dedicated to steam, water, and air. One or more valves 58 may manage the flow to steam, water and air through the manifold.

The manifold 50 may be mounted on a rigid base plate 56 to maintain structural alignment during robotic motion of the arm 34. A plurality of nozzles 54 are provided on the end effector tool 38 that direct the pressurized fluids and air toward the vehicle surface.

Each cleaning nozzle 54 may be capable of adjusting its spray angle between approximately 30 and 40 degrees relative to the vehicle surface. In another embodiment, the nozzles 54 may have a spray angle between 20 and 50 degrees relative to the vehicle surface. In one embodiment, the end effector tool 38 includes twelve nozzles 54. In another embodiment, the end effector tool 38 includes twenty nozzles 54. Any suitable number of nozzles may be used. The system may also incorporate nozzle designs such as pin-jet nozzles, rotary nozzles, or air-atomizing nozzles. The end effector tool 38 may be formed as an elongated cleaning blade or have other suitable configurations.

In certain embodiments, the nozzles 54 include piezoelectric actuators or shape-memory alloy mechanisms that dynamically alter the spray pattern and angle in real time based on the vehicle's contours detected by the imaging system 24. The nozzles 54 may be fabricated from high-performance materials such as stainless-steel-copper alloys, titanium, or ceramic composites that provide excellent corrosion resistance and thermal stability. Some configurations may further include a self-cleaning mechanism that periodically releases high-pressure steam pulses through the nozzle orifices to clear debris or mineral buildup, maintaining consistent performance during prolonged operation.

The controller 40 coordinates operation of the manifold 50 and valves 58 to transition smoothly between cleaning and drying cycles—delivering high-temperature steam and water for cleaning, followed by temperature-controlled air for drying. In another embodiment, the end effector tool 38 has separate nozzles for steam, pressure washing and drying.

The car wash system 10 has a washing fluid delivery system to produce a mixture of steam and water for use in cleaning operations. The washing fluid delivery system includes a steam generator coupled to the cleaning manifold 50 and associated nozzles 54 of the end effector tool 38. The steam generator operates within a controlled temperature range of approximately 100° C. to 180° C. and pressure range of 10 to 20 megapascals (MPa), producing saturated or superheated steam depending on operational demand. Water may be supplied to the steam generator through a preconditioning circuit equipped with flow regulators and thermal sensors that maintain consistent inlet temperature and pressure, ensuring rapid vaporization and stable steam output.

The generated steam is blended with water to provide the prescribed steam-to-water ratio to provide optimal cleaning. The system maintains a steam-to-water volumetric ratio typically between 1:1.5 and 1:2. The water-to-steam ratio may be varied in real time by the controller 40. Adding water to the steam increases the fluid density and momentum, resulting in a higher exit velocity at the nozzles 54, which may improve removal of particulates and surface films while permitting the nozzles 54 to operate at a standoff distance from the vehicle of approximately 1 inch to 3 inches from the vehicle surface. In another embodiment, the stand-off distance may be in the range of 1 inch to 10 inches. The standoff distance from the vehicle may be adjusted to a suitable distance based on other factors such as nozzle size or spray angle fluid pressure or other parameters. The standoff distance minimizes the potential for mechanical contact while maintaining sufficient dynamic pressure for effective cleaning along the vehicle surface. The controller 40 may dynamically adjust both pressure and ratio parameters to accommodate variations in vehicle contour, soil load, and environmental conditions.

The pressurized steam-water mixture is distributed from the generator to the cleaning manifold 50 via thermally insulated, high-pressure conduits rated for cyclic exposure to superheated vapor. Within the manifold 50, a network of precision valves 58—such as solenoid or proportional control valves—modulates flow to each nozzle 54 independently, based on real-time commands from the controller 40. This configuration allows zone-specific adjustment of temperature, flow rate, and velocity. The manifold 50 maintains internal flow channels fabricated from high-grade stainless steel or nickel alloys to resist thermal fatigue, scaling, and corrosion. The integrated control loop continuously monitors discharge pressure and mass flow rate to maintain the commanded steam-to-water ratio with deviations of less than ±2%. This tightly coupled thermal-fluidic control architecture ensures repeatable cleaning performance, optimized energy utilization, and significant reductions in overall water consumption relative to conventional high-pressure wash systems. Collectively, the steam generation and fluid delivery subsystem provides a thermodynamically efficient, precisely controlled cleaning medium that enables the car wash system 10 to achieve high surface cleanliness with minimal environmental impact.

The car wash system 10 further includes an air delivery system and blower assembly operatively connected to the cleaning manifold 50 and end effector tool 38. The air delivery system may provide high-velocity drying of the vehicle surface following completion of the steam cleaning cycle. The end effector tool 38 transitions from steam delivery to air delivery so that the vehicle can transition from cleaning to drying without having to move in the cleaning chamber 20. The controller 40 actuates internal valves 58 to redirect flow paths within the cleaning manifold 50. Temperature-controlled, pressurized air is routed through dedicated channels and discharged through the same nozzles 54 used during cleaning, maintaining consistent alignment and trajectory relative to the vehicle geometry. The air jets are regulated to deliver sufficient flow momentum to remove residual water and moisture from the surface while preventing thermal stress or finish damage. This integrated dual-mode architecture enables the car wash system 10 to perform a continuous wash-to-dry operation without requiring mechanical reconfiguration, thereby improving operational throughput and overall energy efficiency. In another embodiment, separate nozzles 54 on the end effector tool 38 may be provided for drying and washing.

The car wash system 10 may also include a feedback and sensor integration subsystem that enables closed-loop monitoring and control of the cleaning and drying processes. The end effector tool 38 may include sensors configured to detect surface temperature, distance, and moisture during operation. The sensors included with the end effector tool 38 may provide continuous, real-time data to the controller 40 of the vehicle surface. The controller 40 can dynamically adjust cleaning parameters such as steam pressure, fluid flow rate, and nozzle angle to effect cleaning performance based on the end-effector sensors. The sensors on the end effector tool 38 may include infrared temperature sensors, laser or ultrasonic distance sensors, and capacitive or optical moisture detectors or other possible sensors or alternative scanning and imaging technologies such as light detecting and ranging (LiDAR), structured light 3D scanners, or hyperspectral imaging systems, for example.

The sensors on the end effector tool 38 may be integrated within or adjacent to the nozzles 54. The end-effector sensors allow the system 10 to adapt to variations in vehicle geometry or cleaning requirements.

The end effector tool 38 may also include limit switches or mechanical safety switches 60 designed to prevent accidental contact between the end effector tool 38 and the vehicle. These switches 60 are positioned around the outer frame of the effector 38 and extend beyond the nozzles 54. In the event of unanticipated contact or obstruction, actuation of a limit switch 60 immediately triggers a signal to the controller 40, which halts or reverses motion of the robotic arm 34 to avoid impact.

The car wash system 10 may also have a path planning module to generate optimized cleaning trajectories for each robotic arm 34. The path planning module may be integrated within the controller 40. The subsystem utilizes data obtained from the imaging system 24 and corresponding 3D point cloud models to determine the most efficient and collision-free motion paths for cleaning. The controller 40 may implement computational algorithms such as Rapidly-Exploring Random Trees (RRT), Probabilistic Roadmaps (PRM), and Potential Field Methods to dynamically generate cleaning paths based on the unique geometry of each vehicle. The algorithms can analyze the three-dimensional surface data to produce a continuous and smooth trajectory that maximizes coverage while minimizing redundant movement and cycle time. The planned trajectories account for vehicle shape, boundary constraints, and the physical limits of the robotic arm 34.

During system initialization, the path planning module aligns the coordinate systems of the 3D scanners, robotic arms, and vehicle platform through an automatic calibration routine. Once calibration is verified, the controller 40 initiates a scanning sequence to generate a point cloud dataset representing the vehicle's geometry. The path planning process then computes a series of optimized motion segments, typically arranged in a top-to-side zigzag pattern, to achieve complete cleaning coverage. For each point on the vehicle surface, the system calculates corresponding orientation angles—pitch, roll, and yaw—based on the spatial relationship between the end effector tool 38 and the target surface. The resulting data stream provides the robotic control unit with both Cartesian coordinates and orientation commands, ensuring that the end effector tool 38 maintains consistent distance and alignment during the cleaning process. The controller 40 continuously monitors communication with the programmable logic controller (PLC) to manage synchronization, start signals, and feedback status throughout the cleaning cycle.

The dynamic path adjustment module enables real-time modification of the planned trajectories based on sensor feedback and operational conditions. During cleaning, data from the distance and moisture sensors on the end effector tool 38 are transmitted to the controller 40, which analyzes deviations from the expected path or anomalies in surface proximity. The system employs adaptive control logic to recalculate path segments in real time, adjusting nozzle positioning, spray angle, or arm speed as needed. This feedback-driven approach ensures precise cleaning even when vehicle orientation varies slightly from the initial scan data or when environmental disturbances occur. The controller 40 may use an iterative optimization process that minimizes positional error between the planned and actual tool paths, maintaining sub-centimeter accuracy throughout operation.

The controller 40 may also be in communication with the mechanical limit switches 60 and emergency stop systems to prevent unintended collisions or overtravel. Real-time position data is cross-referenced to the vehicle's mapped boundaries to verify compliance with predefined safe zones. If the feedback sensors or limit switches detect an obstacle or contact risk, the controller 40 can halt motion and recalculate an alternative path around the obstruction. The system may also have predictive diagnostics that analyze actuator response time, joint torque, and fluid pressure to anticipate deviations that could affect path accuracy.

In another embodiment, the car wash system 10 may include a closed-loop water recycling and filtration subsystem. The recycling and filtration subsystem captures condensed steam and runoff water, passing it through a series of advanced filtration stages, which may include activated carbon filters, reverse osmosis membranes, or advanced ceramic filtration systems. This process conserves water and ensures that the steam produced is of consistently high purity, minimizing the risk of mineral deposits on vehicle surfaces or within the system itself.

Precise manipulation of these advanced nozzles is achieved through a state-of-the-art robotic system, centered around a multi-axis industrial robot or collaborative robots (cobots). This robot offers an exceptional combination of reach, payload capacity, and precision, making it ideal for the demanding requirements of automated car washing. The robot's kinematic structure allows it to access all areas of a vehicle, including traditionally challenging spots such as the undercarriage, wheel wells, spare tire carriers, customized body components such as spoilers, and intricate grille designs.

The car wash system 10 includes a user interface configured to provide both local and remote operational control through multiple input and interaction modalities. The interface may be implemented as a touchscreen control panel, a mobile or desktop software interface, or a web-based dashboard that enables monitoring and control of cleaning operations in real time. In various embodiments, the user interface may also include augmented reality (AR) displays that overlay operational data and component diagnostics onto a visual representation of the system, assisting in maintenance, calibration, or real-time troubleshooting. Alternative interface options may include voice-controlled systems, allowing operators to issue verbal commands for initiating or modifying cleaning cycles, or mobile device integration that enables remote access, notifications, and performance tracking through smartphones or tablets. Without limitation, the interface can incorporate keyboards, knobs, buttons, sliders, touchscreens, microphones, cameras, or other human-machine interface (HMI) elements to facilitate intuitive interaction with the system. Each of these interface configurations communicates with the controller 40 through secure wired or wireless connections, allowing flexible deployment in commercial or industrial environments.

In terms of environmental sustainability, this system sets new standards for the car wash industry. Its water recycling capabilities typically reduce freshwater consumption by up to 90% compared to traditional car wash systems. Alternative water conservation methods may include atmospheric water generation technology or integration with rainwater harvesting systems. The system's electrical components are designed for high efficiency, and the entire operation can potentially be powered by renewable energy sources such as solar panels, wind turbines, or fuel cells, making it possible to achieve a carbon-neutral car wash operation. Energy storage components such as lithium-ion or solid-state batteries may be used to buffer power fluctuations and store excess energy for use during peak operational loads. The controller 40 coordinates energy distribution across the steam generator, robotic drives, and air delivery system to minimize peak demand and reduce total energy consumption. The system may also employ variable-frequency drives (VFDs) for pump and fan motors, enabling precise control of motor speed and torque to match real-time load requirements.

This advanced automated steam cleaning car wash system represents a convergence of multiple cutting-edge technologies, resulting in a solution that dramatically outperforms traditional car washing methods in terms of cleaning efficacy, efficiency, and environmental impact. Its ability to adapt to each individual vehicle, combined with its learning capabilities, ensures that it can meet the evolving needs of the automotive industry, from traditional combustion engine vehicles to the latest electric and autonomous vehicles. This system not only sets a new benchmark for the car wash industry but also potentially paves the way for the future of automated cleaning technologies across various sectors.

FIGS. 5-8 illustrate the potential applications of an automated steam-based vehicle wash system of the present disclosure for use in a typical car wash tunnel.

FIG. 5 provides a baseline reference depicting a typical car wash tunnel layout. The layout includes essential operational areas such as the main wash tunnel 20, an equipment room, electrical and plumbing connections, storage, and office spaces, in addition to the automated steam-based system 10 within the context of a pre-existing car wash tunnel. A single vehicle, represented as a wireframe model, is shown positioned within the tunnel, surrounded by multiple robotic arms. FIGS. 5-8 show the integration of the disclosed system into existing facilities, emphasizing that no significant structural modifications may be required. The robotic arms are strategically positioned to ensure comprehensive cleaning coverage, particularly in vehicle areas that may be challenging for traditional systems to reach, such as undercarriages, wheel wells, and intricate body components.

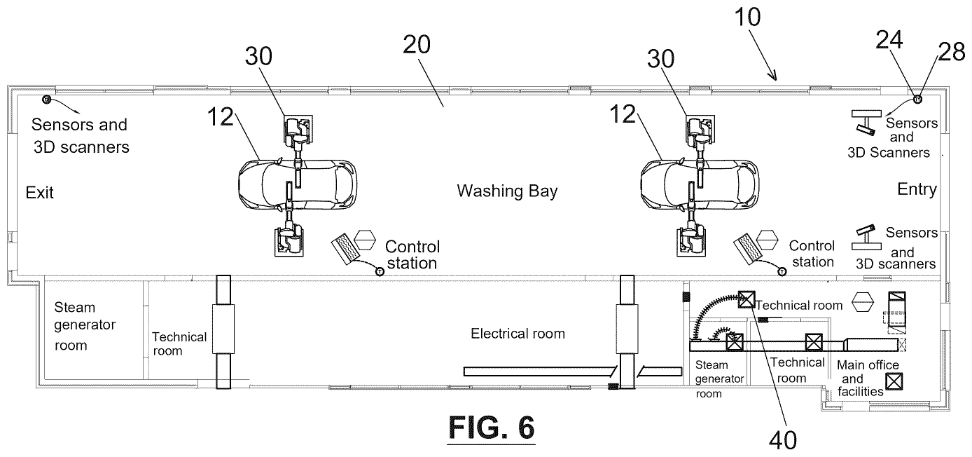

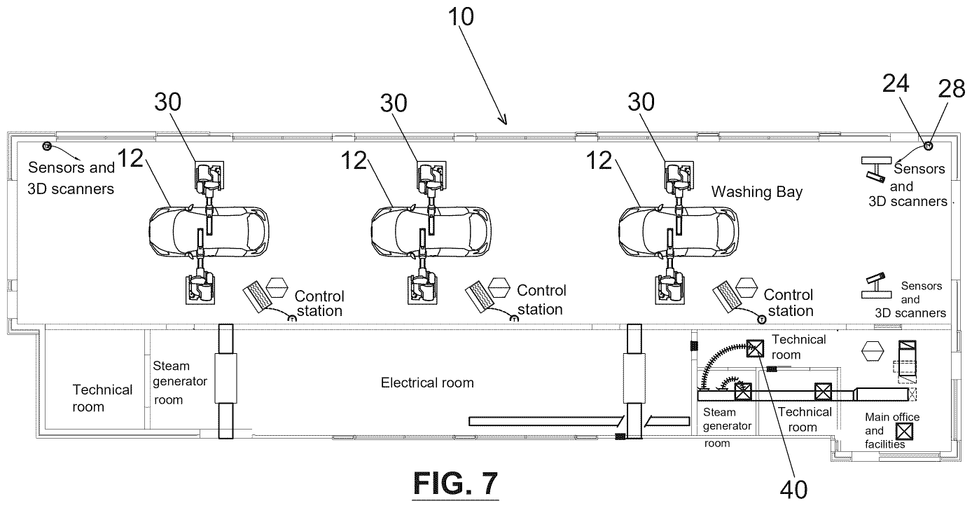

FIG. 6 illustrates an automated car wash system 10 to service two vehicles simultaneously within the same tunnel space. FIG. 7 further depicts three vehicles being processed simultaneously within the same tunnel dimensions. FIGS. 5-8 show the scalability of the system 10, which can substantially increase throughput while maintaining the same overall traditional facility size. The car wash system 10 has a modular design that allows for the addition of further robotic arms, as required, to handle the increased number of vehicles. This capability represents a substantial improvement over conventional systems, potentially tripling the cleaning capacity without the need for costly structural expansion. Such a configuration is expected to lead to increased revenue generation, making it a cost-effective solution for high-volume car wash facilities.

FIG. 8 illustrates a compact car wash configuration and the advantages to redesign the car wash tunnel itself. The compact optimized tunnel design can deliver equivalent or superior cleaning capabilities in a footprint reduced by up to 70% compared to traditional layouts. The smaller tunnel size enables a reduction in real estate costs and expands the potential locations for car wash installations, as facilities can now be established in areas previously deemed too small or expensive. Additionally, this redesign offers significant reductions in construction and operational costs, contributing to overall system efficiency. Furthermore, the reduction in space requirements promotes environmental sustainability by lowering the resource consumption associated with building and maintaining the facility. The compact tunnel also allows existing car wash facilities to repurpose the freed-up space for additional services, thereby creating new revenue streams.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An automated vehicle car wash system comprising:
a cleaning chamber for receiving a vehicle;
an imaging system having a plurality of sensors to scan the vehicle within the cleaning chamber;
a washing fluid delivery system to provide a prescribed ratio of water-to-steam configured for cleaning the vehicle;
an air delivery system configured to provide air for drying the vehicle;
at least one robotic arm positioned in the cleaning chamber positioned adjacent the vehicle;
a cleaning effector attached to the robotic arm and having a plurality of cleaning nozzles operatively coupled to the washing fluid delivery system for delivering the prescribed ratio of water-to steam, and operatively coupled to the air delivery system for delivering air; and
a controller operatively connected to the robotic arm, the washing fluid delivery system, the air delivery system and the imaging system, the controller programmed to:
receive data from the imaging system and generate a three-dimensional surface map of the vehicle; and
control the robotic arm based on the three-dimensional surface map of the vehicle.

2. The system of claim 1, wherein the plurality of sensors comprises at least one three-dimensional (3D) LiDAR sensor and at least one of a stereoscopic camera or time-of-flight camera for generating the three-dimensional surface map of a vehicle.

3. The system of claim 1, wherein the plurality of sensors are positioned overhead and along the sides of the cleaning chamber and are configured to provide the three-dimensional surface map corresponding to an exterior of the vehicle.

4. The system of claim 1, wherein the controller is further programmed to process data from the imaging system to generate a detailed 3D model of the vehicle surface.

5. The system of claim 4, wherein the controller comprises a machine learning module trained to perform object detection using data from the imaging system, the machine learning module being configured to identify exterior vehicle features.

6. The system of claim 1, wherein the controller generates an optimized cleaning trajectory for the robotic arm based on the 3D model and object localization data.

7. The system of claim 6, wherein the controller continuously modifies the cleaning trajectory in real time based on sensor feedback from the vehicle surface.

8. The system of claim 1, wherein the washing fluid delivery system comprises a steam generator producing steam at temperatures between 100° C. and 180° C. and pressures between 10 MPa and 20 MPa, with a variable steam-to-water ratio adjusted according to cleaning requirements.

9. The system of claim 8, wherein the washing fluid delivery system provides a cleaning fluid at the prescribed ratio of steam-to-water being in a volumetric ratio in the range of 1.5 to 2.0.

10. The system of claim 1, wherein the plurality of cleaning nozzles comprise at least one of a variable-geometry nozzle capable of adjusting spray angle between 30° and 40° relative to the vehicle surface.

11. The system of claim 10, wherein the plurality of cleaning nozzles are formed of a composite of stainless steel and copper alloy and includes a self-cleaning mechanism using high-pressure steam pulses.

12. The system of claim 1, wherein the robotic arm comprises six or more degrees of freedom, enabling full access to the vehicle surface, including undercarriage and recessed areas.

13. The system of claim 1, further comprising at least two robotic arms, wherein the robotic arms are synchronized by the controller to perform simultaneous cleaning of different vehicle zones.

14. The system of claim 13, wherein dynamic safety zones are established around the robotic arms based on vehicle localization data to prevent collisions during operation.

15. The system of claim 1, wherein the cleaning effector is configured to switch between steam delivery and air delivery for seamless transition from washing to drying.

16. The system of claim 1, wherein the cleaning effector is attached to a distal end of the robotic arm and further comprises sensors that monitor surface temperature, distance, and moisture to optimize cleaning and drying results.

17. The system of claim 1, further comprising a closed-loop water recycling subsystem including reverse osmosis and activated carbon filtration for reusing condensed steam and runoff.

18. The system of claim 1, wherein the controller includes a user interface configured for local and remote operation through at least one of a touchscreen, mobile device, or voice control inputs.

19. A method of operating an automated steam-based vehicle washing system comprising:
generating a three-dimensional model of a vehicle in a washing chamber using a multi-sensor imaging system;
processing the three-dimensional model data using a machine learning algorithm to detect and localize the vehicle within the washing chamber;
generating a cleaning path for a robotic arm based on the processed three-dimensional model data and vehicle localization;
controlling a steam generator to produce steam;
directing the robotic arm along the generated cleaning path;
applying steam to the vehicle surface through a steam nozzle attached to the robotic arm;
continuously adjusting the robotic arm's position and steam application based on real-time feedback from the multi-sensor imaging system; and
applying forced air to dry the vehicle surface.

20. An automated vehicle cleaning apparatus comprising:
a robotic arm with multiple degrees of freedom,
an end effector attached to the robotic arm having at least one cleaning nozzle;
a steam generator operatively connected to the end effector to provide steam for cleaning the vehicle;
an air delivery system for drying the vehicle;
a three-dimensional imaging system with at least one overhead sensor, at least one side-mounted sensors; and
a control system operatively connected to the robotic arm, steam generator, and three-dimensional imaging system, with a processor configured to receive and process data from the three-dimensional imaging system, and provide a control signal to the robotic arm and steam generator based on the processed image data.
